(19) United States
(12) Patent Application Publication
(10) Pub. No.: US 2007/0045973 A1
(43) Pub. Date: Mar. 1, 2007

(54) Fishing equipment cart

(75) Inventor: Frank Grosso, Coral Springs, FL (US)

Correspondence Address: Alan M. Weisberg, Esq.;Christopher & Weisberg, P.A., Suite 2040, 200 East Las Olas Boulevard, Fort Lauderdale, FL, 33301, US

(73) Assignee: FAD Marketing, Inc.

(21) Appl. No.: 11/214,702

(22) Filed: Aug. 29, 2005

(51) Int. Cl. B62B 1/00

(52) U.S. Cl. 280/47.26

(57) ABSTRACT

A compact fishing equipment cart having foldable support trays capable of supporting various types of fishing related equipment. The cart includes a substantially rectangular upright frame having front and rear walls, opposing side walls, a top wall and a bottom wall forming an enclosure. At least a portion of the front wall of the enclosure includes one or more substantially planar support trays. Each tray is pivotably connected to the front of the frame and is configurable from an open position where objects can be placed on the top of the tray, to a closed position where each tray forms a port of the front wall of the frame. Attachment fins may be removably mounted to a side of the frame and is each adapted to hold one or more fishing poles. The cart further includes various pouches, pockets, and compartments on the exterior of the frame, in which to store objects such as folding chairs, cups, and the like, and includes one or more shelves within the enclosure to provide additional storage space.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a fishing cart and more specifically to a mobile, compact fishing cart that stores fishing equipment within and upon its frame and that includes movable support trays that pivot outward when in an open position in order to support the fishing equipment and which form at least a portion of the frame of the cart when in a closed position.

### BACKGROUND OF THE INVENTION

Fishing has grown into an extremely popular recreational pastime. Although one can escape to a lake or stream with just their fishing pole, a few hooks and some bait, all stored in a tackle box, more experienced fisherman understand that many different types of fishing equipment are usually needed to make the outing a more rewarding, enjoyable and successful one. If more than one fisherman is present on the outing, more than one fishing pole will be needed. This would require additional bait, lures, hooks, and other fishing tools. Thus, it is evident that a simple tackle box would not sufficiently hold all the equipment necessary for the fishing outing.

In addition to the fishing equipment, other items such as food, drinks, cups, eating utensils, chairs or stools, ice, coolers, or reading material would have to be carried separately to the site. Needless to say, a simple fishing trip could turn into a major excursion due to the amount of equipment and ancillary items that would need to be brought to the fishing site.

Prior art fishing carts exist that can be wheeled to the fishing site and include storage compartments or hooks for various types of equipment. However, the prior art fishing carts do not have integrated shelves that can rotate to form a portion of the cart itself, thus forming a lower profile cart that is easier to move as well, nor do they have a frame that can protect the contents of the fishing equipment within the cart during transport. Further, prior art carts are bulky and expensive to manufacture, fail to include a drainage system to protect the equipment within the cart from water damage, fail to include space for the fisherman to skin and de-bone the fish, or remove hooks from the fish's mouth, and do not include proper recesses adapted for use with specific fishing equipment, such as fishing poles, bait buckets, and tackle boxes. The present invention is directed to a fishing cart that avoids these and other disadvantages.

### SUMMARY OF THE INVENTION

The present invention advantageously provides an apparatus that stores fishing equipment in one, compact fishing cart. According to one aspect of the invention, a fishing cart comprising a frame forming an enclosed area is provided. The enclosed area is defined by top and a bottom wall, a rear and a front wall, and opposing side walls. The front wall includes one or more pivotable substantially planar support members, wherein the support members form at least a portion of the front wall when in a closed position and may support an object thereon when in an open position.

In another aspect of the invention, a fishing cart is provided that includes a frame forming an enclosed area defined by top and a bottom wall, a rear and a front wall, and opposing side walls, where each side wall includes attachment hooks. The cart also includes one or more substantially planar support trays rotatable between and open position and a closed position, such that when in the closed position, each said support tray forms at least a portion of the front wall of the frame.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front perspective view of the fishing equipment cart of the present invention with the front trays opened;

FIG. 2 is a front perspective view of the fishing equipment cart of the present invention including an attached fishing pole holder;

FIG. 3 is a rear perspective view of the fishing equipment cart of the present invention;

FIG. 4 is a rear view of the fishing equipment cart of the present invention;

FIG. 5 is a side, cut-away view of the fishing equipment cart of the present invention; and

FIG. 6 is a front perspective view of the fishing equipment cart of the present invention with the front trays closed.

### DETAILED DESCRIPTION OF THE INVENTION

The present invention advantageously provides a portable fishing equipment storage cart that can store a variety of fishing-related objects and equipment in a low-profile, easy-to-maneuver enclosed frame in order to safely transport fishing equipment to a fishing site. The cart includes an enclosed frame having a series of planar support trays. The trays form a portion of the front wall of the frame and can pivot outward in order to provide a storage surface thereon. The shelves can be folded upward and returned to their original position after use, thus minimizing the size of the cart. Advantageously, the cart includes attachment hooks on one side to receive a mountable fishing pole attachment fin. The fin is designed to receive and secure fishing poles thereto. Additional recesses and compartments adorn the frame for additional storage capability.

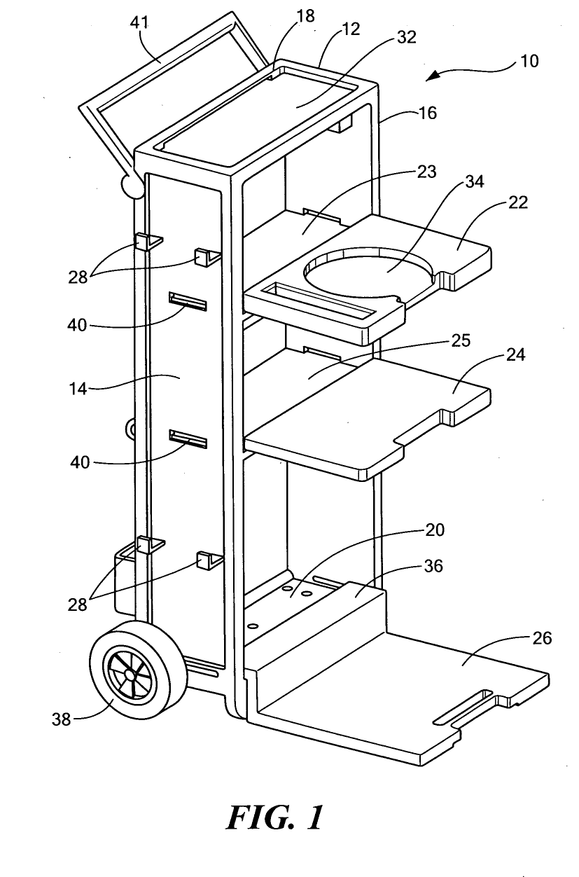

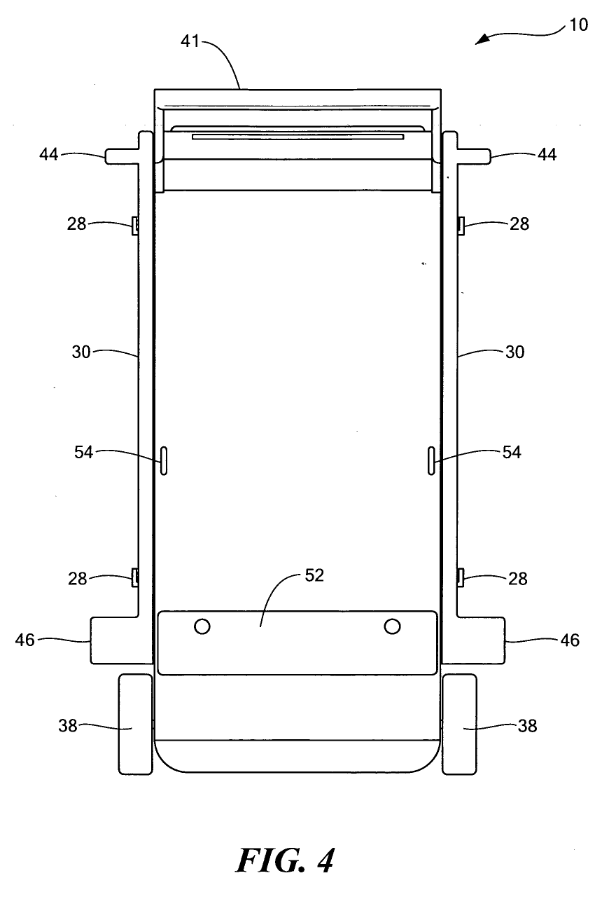

Referring now to the drawing figures in which like reference designators refer to like elements there is shown in FIG. 1 an apparatus constructed in accordance with the principles of the present invention and designated generally as “10”. Fishing cart 10 includes a substantially rectangular frame 12 having opposing side walls 14 and 16, top wall 18, bottom wall 20, and rear wall 21 (shown in FIG. 4). Two or more wheels 3 8 may be affixed to the bottom of frame 12 to allow cart 10 to be wheeled to a desired location. Frame 12 may be made of metal, plastic, or any other sturdy material.

FIG. 1 illustrates cart 10 in an open configuration with a plurality of trays open to support various sized objects. In one embodiment, three substantially planar support trays, 22, 24 and 26 are opened to receive and support objects thereon. When in their closed position, the trays form at least a portion of the frame's front wall. Advantageously, this results in a more compact frame 12, since the trays 22, 24, and 26, when not in use, are folded up and secured and do not extend beyond the plane of the front wall of frame 12. Storage shelves 23 and 25 provide additional storage space within frame 12. The invention disclosed herein is not limited to a particular number of storage shelves or trays or a particular size frame.

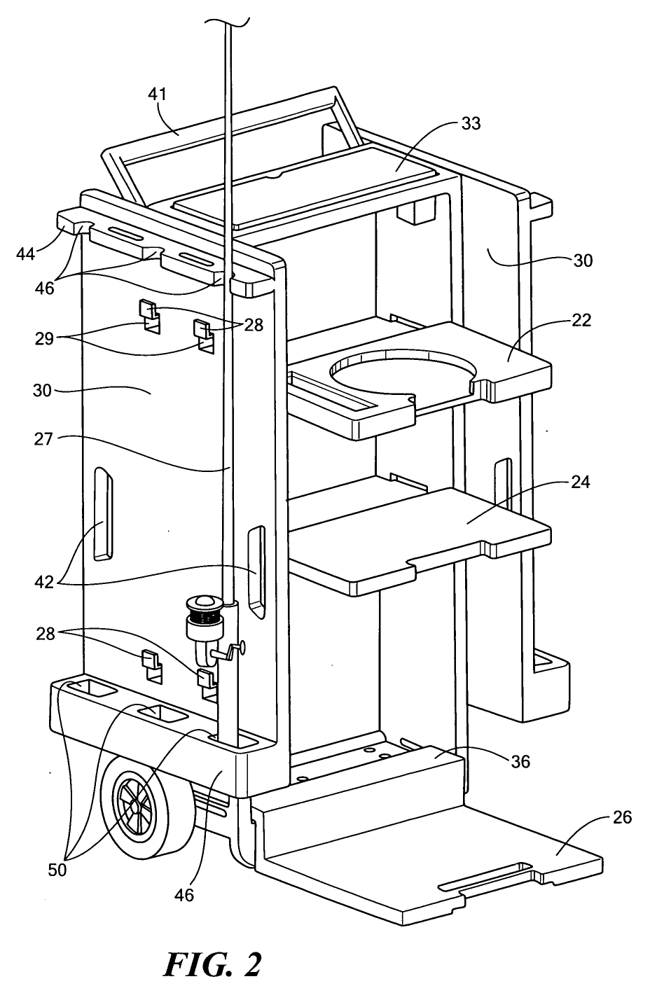

Referring again to FIG. 1, side wall 14 includes four attachment hooks 28, although a larger or smaller number of hooks may also be used. Each hook 28 is sized to receive a corresponding alignment slot 29 located on a fishing pole attachment fin 30 (FIG. 2), which is designed to retain one or more fishing poles. In FIG. 1, the top wall 18 of frame 12 includes a cutting board well 32. Cutting board well 32 is sized to receive a cutting board 33 (FIG. 2) that includes a smooth, hard surface that can be used for cutting fish or the like. In one embodiment, top wall 18 includes a recess (not shown) upon which cutting board 32 may be placed and removably secured. Tray 22 may include a circular utility well 34 to secure a round object such as a bucket for storing bait. Tray 24 may be used to support items such as a tackle box, sandwiches, or the like. Any of the trays may include wells or recesses of different sizes and shapes in order to accommodate different items.

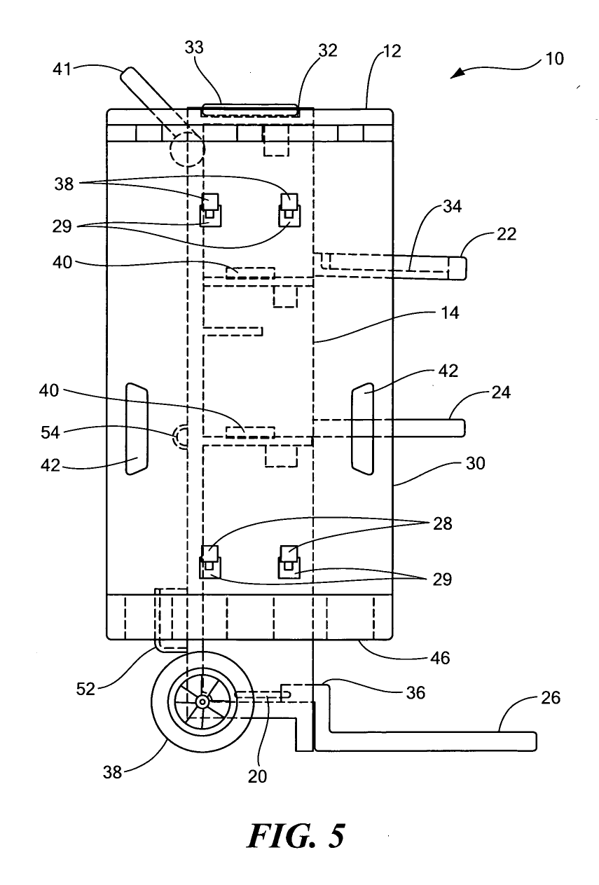

Lowermost tray 26, when open, rests upon or proximate the ground. Thus, tray 26 may support larger and more bulkier objects such as ice or a cooler. Tray 26 includes a raised lip 36, which is raised above a lower ledge of frame 12. The shape of lip 36 allows tray 26 to be opened and placed upon the floor, thus allowing heavier items to be supported thereon. Each of the trays shown in FIG. 1 is supported in its open position by a support hinge (an example of which is shown in FIG. 5), which connects each tray to frame 12.

Frame 12 is advantageously equipped with drainage slots 40. Drainage slots 40 can be included throughout frame 12 including its bottom wall 20, side walls 14 and 16, and rear wall 21. A handle 41 is connected to frame 12 toward the back of side walls 14 and 16. Handle 41 can swivel to allow the user to grasp the handle 41 at different positions in order to facilitate moving and steering of cart 10. Handle 41 can be folded across top wall 18 when not in use in order to maintain the low profile of the cart.

FIG. 2 illustrates apparatus 10 after attachment fin 30 has been placed upon hooks 28. Fin 30 is a planar, substantially rectangular attachment device that is removably affixed to a side wall 14 of frame 12 via hooks 28. Fin 30 includes alignment grooves 29 that are placed over and lifted off corresponding hooks 28 by use of two handles 42. Handles 42 may be two elongated grooves cut into fin 30 that allows the user to grasp fin 30 via the handles and place the fin 30 on top of hooks 28. Other types of handles may be used to facilitate the placing of fin 30 on frame 12. A second fin 30 may be placed upon side wall 16 in similar fashion. Although corresponding hooks 28 and grooves 29 are one way to removably mount fin 30 to frame 12, other mounting means common in the art may also be used.

Fin 30 includes an upper bracket 44 and a lower bracket 46. Upper bracket 44 contains a series of indentations 46, each sized to receive and secure the distal end of a fishing pole 27. Lower bracket 46 contains a series of larger recesses 50, each aligned with a corresponding indentation 48 in upper bracket 44. Recess 50 houses the larger, proximate end of the fishing pole. Thus, fin 30 provides an attachment device that can be placed on each side or both sides of frame 12 and which can hold several fishing poles thus obviating the need to hand-carry or separately carry each pole.

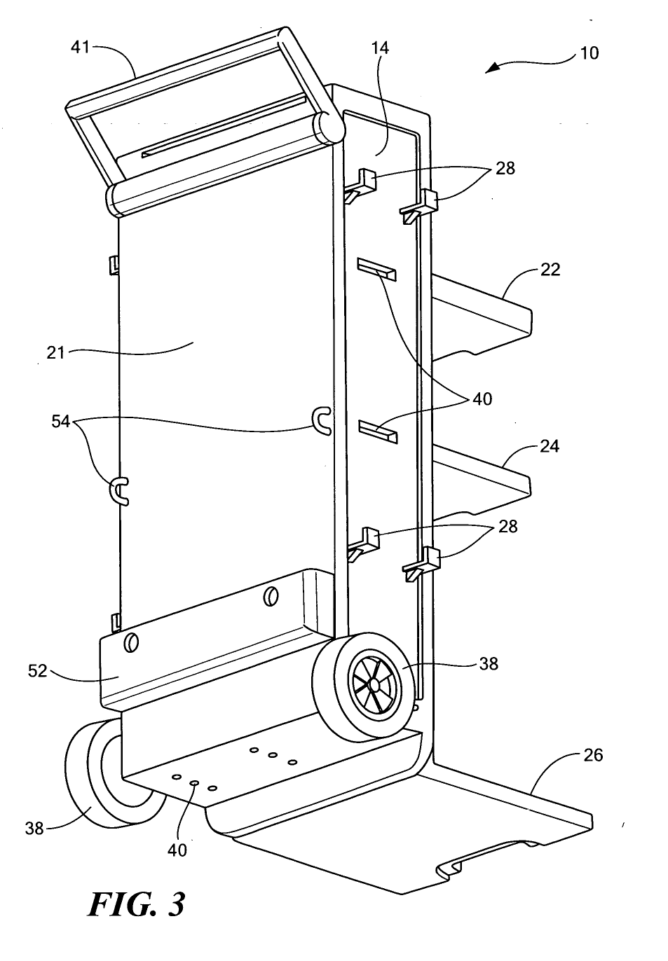

FIG. 3 represents a rear, perspective view of cart 10. Rear wall 21 of frame 12 may include a portable stool holder 52. Holder 52 is a pocket sized to receive and store a folded or collapsible chair or stool. Holder 52 can be comprised of netting, plastic, metal or other material. Bungee hooks 54 serve to further secure the folded stool against frame 12. Rear wall 21 may include additional compartments such as cup holders, hooks, pockets, or netting to secure smaller items to frame 12.

FIG. 4 is a rear view illustration of cart 10. Rear wall 21 includes holder 52 and bungee hooks 54 in order to secure a folded or collapsed stool. Rear wall 21 of frame 12 can include a storage netting 56 to hold keys, cameras or other items. Handle 41, as discussed above, is pivotable around the top wall 18 of frame 12. In one embodiment, a handle activation button 43 can be pressed to allow handle 41 to be swung down on top of top wall 18 when not in use.

Fin 30 can be seen attached to each side of frame 12. The narrow profile of cart 10 is due to the flush relationship of removable fins 30 with their respective side walls 14 and 16, the ability of handle 41 to rotate flush against top wall 18, and the collapsibility of each storage tray 22, 24, and 26 when not in use. The narrow profile of cart 10 is maintained since fins 30 can store fishing poles up against the sides of frame 12, and holders 52 and 56 can store such items as folded stools against rear wall 21. Thus, frame 12 of cart 10 provides a compact storage compartment that can provide safe storage for objects both within the frame 12 and against its exterior.

FIG. 5 provides a side, cut-away view of the fishing equipment cart 10 of the present invention. Trays 22, 24 and 26 can be seen in their open configuration. Tray 22 may include a recess 34, sized to fit a round, cylindrical object such as the bottom of a bait bucket. Tray 24 is situated lower than tray 22 and with enough clearance space to accommodate taller objects. One or more rubber strips (not shown) may be placed on the upper surface of one or more trays in order to reduce the likelihood that objects may slide off the surface. An additional securing apparatus, such as a tie-down hook (not shown) can be used with twine or rope to better secure objects to the tray.

The trays 22, 24 and 26 are each shown in an open configuration, where each is rotatably connected to its corresponding shelf (23, 25 and 20) via a hinge (not shown). Any type of support hinge can be used to rotatably connect each of the trays to the frame 12. Thus, trays 22 and 24 can be folded along the hinge, separating the tray from its respective shelf. A clasp or other type of locking mechanism can be used to maintain each tray in a closed configuration. Fin 30 is affixed to side wall 14, shown in phantom in, and includes handles 42 to assist the user in placing the fin 30 on frame 12. In FIG. 5, tray 26 is shown as the lowermost tray of cart 10, and, when fully extended, rests on or proximate the ground or floor. Thus, tray 26, when opened, is able to support a larger item such as a cooler.

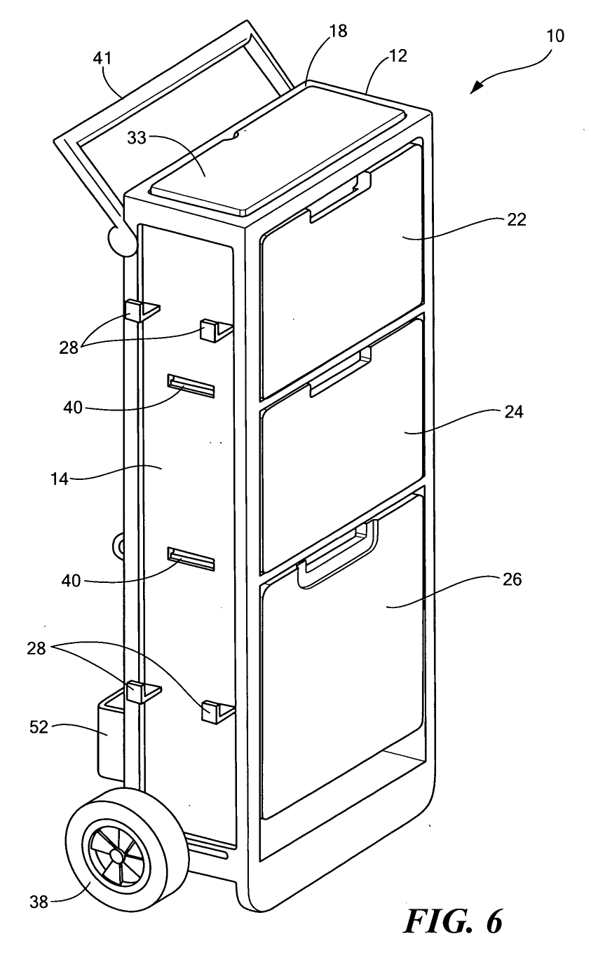

Each tray, when in a closed configuration, forms all or a portion of the frame's front wall. FIG. 6 illustrates this configuration. When all the trays of cart 10 are closed, frame 12 forms a compact, watertight enclosure, capable of being moved from one location to another by use of handle 41 and wheels 38. Trays 22, 24 and 26 may be secured in their closed position by any securing means known in the art. Items may be stored within frame 12 upon shelves 23 and 25 after trays 22 and 24 have been closed. Furthermore, as described above, other items such as collapsed chairs or stools, fishing poles, bait and tackle, and food and beverages can be stored on the exterior of frame 12. One or both fins 30 may be attached to a respective side of frame 12. Thus, cart 10 accommodates all the fishing equipment needed in a fishing outing as well as other related items in one compact, water-resistant frame 12, without the need to separately carry many of these items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A fishing cart comprising a frame forming an enclosed area defined by top and a bottom wall, a rear and a front wall, and opposing side walls, wherein the front wall includes one or more pivotable substantially planar support members, wherein the support members form at least a portion of the front wall when in a closed position and may support an object thereon when in an open position.

2. The fishing cart of claim 1, wherein a lowest support member, when in the open position, is proximate the ground in order to support heavy objects.

3. The fishing cart of claim 1, wherein the rear wall of the frame includes an inner surface and an outer surface, the outer surface of the rear wall including a receptacle sized to house a foldable stool.

4. The fishing cart of claim 1, further comprising a fishing pole holder removably secured to a side of the frame via attachment means.

5. The fishing cart of claim 4, wherein the fishing pole holder comprises:
an upper bracket having one or more indentations for securing the upper ends of a plurality of fishing poles; and
a lower bracket having receptacles for supporting the lower ends of the plurality of fishing poles.

6. The fishing cart of claim 5, wherein the attachment means comprises:
one or more attachment hooks extending from the side wall of the frame; and
one or more attachment grooves within the fishing pole holder such that the attachment grooves are demountably engaged upon the attachment grooves thus securing the fishing pole holder to the frame.

7. The fishing cart of claim 1, wherein the frame forms a weatherproof compartment when the one or more support members are each in the closed position.

8. The fishing cart of claim 1, each support member having an upper and lower surface, wherein the upper surface of at least one said support member includes a recess adapted to support a piece of fishing equipment when the support member is in the open position.

9. The fishing cart of claim 1, wherein the top wall of the frame further includes a recess adapted to removably receive a cutting board.

10. The fishing cart of claim 1, the frame further including one or more drainage holes.

11. The fishing cart of Claim l, further comprising a rotatable handle affixed to the frame.

12. The fishing cart of claim 4, wherein the fishing pole holder further comprises a handle to allow for removable attachment of the holder to the frame.

13. The fishing cart of claim 1, wherein the frame further comprises one or more interior shelves sized to support objects thereon.

14. A fishing cart comprising:
a frame forming an enclosed area defined by top and a bottom wall, a rear and a front wall, and opposing side walls, each said wall having an inner and an outer surface; and
one or more substantially planar support trays rotatable between and open position and a closed position, such that when in the closed position, each said support tray forms at least a portion of the front wall of the frame.

15. The fishing cart of claim 14, further comprising:
attachment flanges affixed to the outer surface of at least one of the opposing side walls;
an attachment fin demountably engaged upon the side wall of the frame, each said attachment fin including:
a bracket assembly to retain one or more elongated objects;
attachment grooves removably mountable upon the attachment flanges; and
a handle to facilitate mounting of the one or more fins upon the side wall of the frame.

16. The fishing cart of claim 15, wherein the bracket assembly comprises an upper bracket sized to retain a distal end of a fishing pole and a lower bracket sized to retain a proximate end of the fishing pole.

17. The fishing cart of claim 16, the frame further comprising one or more storage shelves within the enclosed area.

18. The fishing cart of claim 14, wherein the frame forms a weatherproof compartment when the one or more support trays are each in the closed position.

19. The fishing cart of claim 14, each support tray having an upper and lower surface, wherein the upper surface of at least one said support tray includes a recess adapted to support a piece of fishing equipment when the support tray is in the open position.

20. The fishing cart of claim 14, wherein the top wall of the frame further includes a recess adapted to removably receive a cutting board.

21. The fishing cart of claim 14, the frame further including one or more drainage holes.

22. The fishing cart of claim 15, further comprising a rotatable handle affixed to the frame.
